(19) United States
(12) Patent Application Publication
(10) Pub. No.: US 2024/0271810 A1
(43) Pub. Date: Aug. 15, 2024

(54) AIR-CONDITIONING SYSTEM

(71) Applicant: TRUMA GERAETETECHNIK GMBH & CO. KG, Putzbrunn (DE)

(72) Inventors: Herbert KASTENMEYER, Putzbrunn (DE); Simon STRUCK-SÜSSMEIER, Putzbrunn (DE); Sudarsan VEDANTHA, Putzbrunn (DE); Lars ZIMMERMANN, Putzbrunn (DE)

(21) Appl. No.: 18/564,733

(22) PCT Filed: May 2, 2022
(86) PCT No.: PCT/EP2022/000040

§ 371 Date: Nov. 28, 2023

(30) Foreign Application Priority Data
May 31, 2021 (DE) 102021002780.9

(51) Int. Cl. F24F 11/32; F24F 11/86; F24F 11/88; F24F 140/60

(52) U.S. Cl. CPC F24F 11/32; F24F 11/86; F24F 11/88; F24F 2140/60

(57) ABSTRACT

deviation of the supply voltage from a predefined setpoint value, switches the electronics component off in a switch-off operation, wherein the monitoring device automatically switches the switched-off electronics component back on if, for one thing, after the switch-off a predefined switch-on condition is satisfied and if, for another thing, a number of switch-off operations within a predefined time period is smaller than a predefined tolerance value, wherein in the case that the number of switch-off operations within the predefined time period is greater than the predefined tolerance value, the monitoring device switches the switched-off electronics component on when the monitoring device has received an acknowledgment signal, wherein the monitoring device signals the case that the number of switch-off operations within the predefined time period is greater than the predefined tolerance value, and wherein the monitoring device sets a counter for the number of the switch-off operations to a start value when switching the device on.

### FIELD OF DISCLOSURE

The present disclosure relates to an air-conditioning system having an electronics component and a monitoring device.

### BACKGROUND

Monitoring circuits are employed to disconnect electronic loads from the supply in the event of voltage or frequency sags. This avoids damage to the load, to the supply and to the switching elements (see, e.g., DE 10 2018 213 747 A1). Typically, the load is reconnected when the supply is considered stable after an outage. In the prior art, it is also known to wait for a predetermined or random waiting time after switch-off. A monitoring circuit is described, for example, in DE 10 2018 103 127 A1.

Accordingly, there is a need to propose an air-conditioning system having a monitoring device for an electronics component which provides an optimized handling of errors in the available supply voltage, e.g. the supply voltage.

### SUMMARY

The present disclosure achieves the object by an air-conditioning system having an electronics component and a monitoring device, the electronics component being a compressor, wherein the monitoring device monitors a supply voltage available to the electronics component and, in the event of a deviation of the supply voltage from a predefined setpoint value, switches the electronics component off in a switch-off operation, and wherein the monitoring device automatically switches the switched-off electronics component back on if, for one thing, after the switch-off a predefined switch-on condition is satisfied and if, for another thing, a number of switch-off operations within a predefined time period is smaller than a predefined tolerance value, wherein in the case that the number of switch-off operations within the predefined time period is greater than the predefined tolerance value, the monitoring device switches the switched-off electronics component on when the monitoring device has received an acknowledgment signal, wherein the monitoring device signals the case that the number of switch-off operations within the predefined time period is greater than the predefined tolerance value, and wherein the monitoring device sets a counter for the number of the switch-off operations to a start value when switching the device on.

The air-conditioning system thus accomplishes a safe restart of an electronic load after supply dips as an unattended and usually automatically operating system. The present disclosure is based on the following findings here: If the electronics component itself is at least partly the cause of the switch-off, there is the risk that a dip in the supply will be caused again after the load is connected. This is detected and the load is switched off again. In an unattended, independently or automatically operating air-conditioning system, a very large number of switching cycles would therefore be carried out in a short time, which may lead to heavy wear in relays, motors and generators. In addition, the high starting current may cause portable voltage sources (e.g. accumulators, gasoline/diesel-powered generators) to be discharged excessively and unnoticed by the user. Conversely, for example, when used in motorhomes etc., occasional interruptions or dips in the voltage supply may occur without each interruption requiring user intervention.

The air-conditioning system according to the invention, or specifically the monitoring device, accepts an input from a user. In the event that no automatic start takes place because of the switch-off processes that are too frequent, the user has to enter an acknowledgment signal realized in any desired form. Thus, he or she must actively initiate a further switch-on of the electronics component in the case of too frequent malfunctions. The user is informed that an acknowledgment signal is required by the monitoring device signaling the case that the number of switch-off operations within the predefined time period is greater than the predefined tolerance value. This is effected, e.g., visually by an LED lighting up or by an acoustic signal. In general, the air-conditioning system has any desired output device. The counter for the number of switch-off operations is set or reset to a start value when the air-conditioning system is switched on. Therefore, the user can respond to the signal that no automatic switch-on of the electronics component takes place by first switching the whole air-conditioning system off and then switching it back on.

In one configuration, the monitoring device consists of a monitoring circuit and a control unit. The monitoring device monitors the available supply voltage with respect to at least one setpoint value. Preferably, the setpoint value is the amount of the voltage or the frequency of the voltage. Furthermore, the setpoint value may refer to the stability of the respective parameters of the supply voltage. When a deviation of the supply voltage from at least one setpoint value occurs, the monitoring device—or, in the aforementioned configuration, more precisely: the control unit—switches the electronics component off. Thus, a switch-off operation takes place. After the switch-off, the monitoring device continues to monitor the available supply voltage. If it determines that the deviation no longer exists, that is, that all setpoint values are satisfied, the monitoring device is, in principle, designed to start the electronics component automatically, i.e. without intervention by a user. The automatic start is tied to the fact that the number of switch-off operations within a predefined period of time is less than a tolerance value. If the number is greater than the tolerance value, no automatic switch-on operation takes place. The monitoring device thus only controls the electronics component independently with regard to switch-off and switch-on until too many deviations occur in the supply voltage available to supply the electronics component. For this purpose, a counter and a timer are employed, for example.

Thus, in the air-conditioning system according to the invention, the failures are considered that lead to a switch-off of the electronics component as an electrical load. As a rule, operation of the load is automatically resumed after the failures. In this way, unnecessary signaling of errors is avoided. In this context, a certain number of errors caused by the automatic switch-on are tolerated and the air-conditioning system is kept in operation to the extent possible. Finally, in one configuration, failures that are longer than a predefined time period apart, and therefore presumably independent of each other, are not evaluated to the effect that automatic switch-on needs to be prevented.

One advantage of the air-conditioning system consists in that the user is informed and has to act only in case of too frequent failures. In the normal case of stable voltage supply, an unattended operation is possible. Furthermore, it is advantageous that frequent switching on and off (e.g. due to overloading of the supply when switching on) is avoided.

The air-conditioning system according to example embodiments can be described again in other words: The air-conditioning system responds, for example, to voltage or frequency sags in a supply voltage available to the electronics component by switching off the electrical load given by the electronics component. When the supply stabilizes again, operation of the load is automatically resumed only if the number of failure-related switch-on operations within a particular period of time is less than a predefined maximum value. If the number of failure-induced switch-on operations within the predefined time period is exceeded, the electronics component will remain in a deactivated state and the user will have to intervene, for example by switching the air-conditioning system off and on or by resetting the counter by means of an acknowledgment signal. In one configuration, the counter for the switch-off operations is reset when the air-conditioning system remains in the state with the load switched on for a certain period of time.

One configuration provides that the predefined switch-on condition consists in that a predefined waiting time has elapsed and/or that the supply voltage corresponds to the predefined setpoint value and/or that a system value of the air-conditioning system is within a predefined value range. In this configuration, criteria are specified, at least one of which must be satisfied, depending on the variant, in order for switching on the electronics component to be possible again in principle. The system value is, for example, a pressure against which a compressor as an electronics component must work.

One configuration provides that the monitoring device counts a number of switch-off operations and, in the case that after a switch-on of the electronics component a predefined activity time period has been exceeded without a further switch-off operation, resets a counter for the number of the switch-off operations to a start value. Therefore, if no deviations of the supply voltage occur within a certain time or if no switch-off operation is required, a counter for the switch-off operations is reset to a start value, e.g. the value zero.

### BRIEF DESCRIPTION OF DRAWINGS

In detail, there is a large number of possibilities to configure and further develop the air-conditioning system according to the invention. In this regard, reference is made to the following description of exemplary embodiments in conjunction with the drawing, in which:

FIG. 1 shows a schematic illustration of the air-conditioning system.

### DETAILED DESCRIPTION

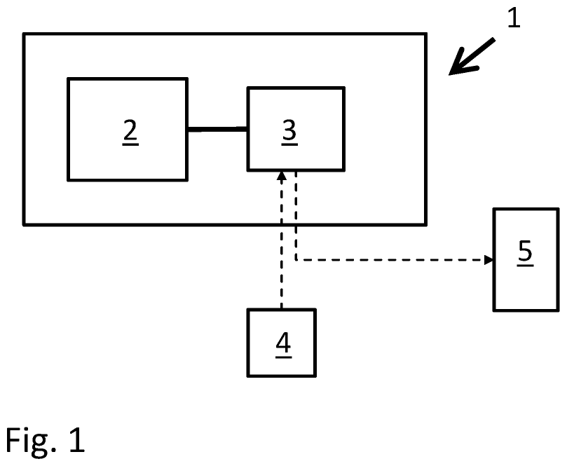

FIG. 1 illustrates, highly schematically, an air-conditioning system 1 with an electronics component 2, which is a compressor. The air-conditioning system 1 serves to implement the refrigeration process as is described, for example, in WO 2007/042065 A1.

A monitoring device 3 monitors the supply voltage that is applied to the electronics component 2, which in this context is regarded as an electrical load. When there is a deviation from at least one predefined setpoint value of the voltage applied, the monitoring device 3 will switch off the electronics component 2. The setpoint value is related to, for example, the amplitude or the frequency of the voltage or, e.g., to the behavior of the amplitude and frequency in terms of time. Switching off prevents damage to the electronics component 2, to the parts serving for switching the electronics component 2, and also to the voltage supply itself.

The automatic switch-on of the electronics component 2 by the monitoring device 3 is initially tied to a switch-on condition being fulfilled. The switch-on condition consists, for example, in that a specific waiting time has elapsed after switch-off, or that the supply voltage corresponds to the setpoint value again, i.e. that the deviation no longer exists, or that a system value of the air-conditioning system 1 is within a predefined value range. The system value is, for example, the pressure of the coolant against which the compressor works.

In addition to the switch-on condition, automatic switch-on requires that the number of switch-off operations within a particular period of time is smaller than a tolerance value. If the number is greater than the tolerance value, the monitoring device 3 will not automatically switch on the electronics component 2. Rather, in this case, in one configuration, a response from a user is demanded. This prevents the electronics component 2 from being automatically switched off and back on again too many times in succession. In the illustrated configuration, this case where the tolerance value has been exceeded is signaled by means of an output device 5 and the monitoring device 3 then waits to receive an acknowledgment signal. In the embodiment shown, this may be input using an input unit 4. The connections between the monitoring device 3, the output device 5 and the input unit 4 are wireless here, for example. When an acknowledgment signal is input, the monitoring device 3 switches the electronics component 2 back on and also resets a counter for the switch-off operations.

The controller, according to the invention, of the air-conditioning system with regard to the monitoring of the supply voltage can be described, for example, by the following finite-state machine:

The air-conditioning system starts in the OFF state. In this OFF state, a counter CNT is set to zero. As a result of an action by a user, e.g. the actuation of a switch or the input of a switch-on signal, the air-conditioning system is transferred to the READY state. In this state, the electronics component 2 as an electrical load is in the switched-off state. In the OPERATION state, the electronics component 2 is switched on and active. In the OPERATION state, the air-conditioning system 1, which is configured as an air-conditioning system, for example, thus cools the room air. A changeover between the READY and OPERATION states is effected automatically (e.g. by closed-loop control of the target temperature or another set value). The user can return the system to the OFF state again at any time, i.e. switch it off, by taking an appropriate action. When changing over to the OPERATION state, a timer is set to a specific time Y and is started.

If it is required to switch off the electronics component 2 in the OPERATION state as a result of a deviation of the supply voltage from at least one setpoint value, the counter CNT is incremented by 1 and compared with a tolerance value X.

If the counter CNT is smaller than the threshold value X, the air-conditioning system will change from the OPERATION state to the UNSTABLE state. When the supply voltage subsequently stabilizes again, the electronics component 2 is switched on again and the air-conditioning system 1 starts operation.

If the counter CNT is greater than the threshold value X, the air-conditioning system will change from the OPERATION state to the ERROR state, which will be signaled to the user (e.g. by switching on an LED). The ERROR state can only be exited again by user intervention. The intervention consists, for example, in switching off the air-conditioning system, that is, in making the transfer to the OFF state. Alternatively, the user generates an acknowledgment signal that effects an error reset.

In the event that no deviation of the supply voltage is registered during a given period of time and therefore no disconnection of the electronics component is necessary, the counter CNT is reset to zero. In other words: If the air-conditioning system remains in the OPERATION state and the timer—set to time Y at the outset—expires, the counter CNT for counting the switch-off operations is set to zero.

While, in the aforementioned configuration, the timer for monitoring the error-free operating time or the number of switch-off operations occurring was started when the air-conditioning system changed over to the OPERATION state, an alternative configuration provides for the timer to be started not only when the changeover to the OPERATION state takes place, but also upon changeover from the UNSTABLE state to the READY state. In this way, the time that the air-conditioning system 1 spends in the READY state is taken into account. This is interesting, for instance, if the electronics component 2 is the compressor mentioned and if the latter needs a time for reaching a target temperature that is shorter than the time period Y.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An air-conditioning system comprising:
an electronics component and a monitoring device, the electronics component being a compressor,
wherein the monitoring device monitors a supply voltage available to the electronics component and, in the event of a deviation of the supply voltage from a predefined setpoint value, switches off the electronics component in a switch-off operation,
wherein the monitoring device automatically switches the switched-off electronics component back on if, for one thing, after the switch-off a predefined switch-on condition is satisfied and if, for another thing, a number of switch-off operations within a predefined time period is smaller than a predefined tolerance value,
wherein in the case that the number of switch-off operations within the predefined time period is greater than the predefined tolerance value, the monitoring device switches the switched-off electronics component on when the monitoring device has received an acknowledgment signal,
wherein the monitoring device signals the case that the number of switch-off operations within the predefined time period is greater than the predefined tolerance value, and
wherein the monitoring device sets a counter for the number of the switch-off operations to a start value when switching the device on.

2. The air-conditioning system according to claim 1,
wherein the predefined switch-on condition consists in that a predefined waiting time has elapsed and/or that the supply voltage corresponds to the predefined setpoint value and/or that a system value of the air-conditioning system is within a predefined value range.

3. The air-conditioning system according to claim 1,
wherein the monitoring device counts a number of switch-off operations and, in the case that after a switch-on of the electronics component a predefined activity period has been exceeded without a further switch-off operation, resets a counter for the number of the switch-off operations to a start value.
